(19) United States
(12) Patent Application Publication
(10) Pub. No.: US 2026/0181431 A1
(43) Pub. Date: Jun. 25, 2026

(54) REDUCING REFERENCE SIGNAL MEASUREMENTS IN WIRELESS NETWORKS

(71) Applicant: SHARP KABUSHIKI KAISHA, Sakai City (JP)

(72) Inventors: Sudeep Hegde, Stuttgart (DE); Majid Ghanbarinejad, Lake Forest, CA (US); Zhanping Yin, Vancouver, WA (US); Rudraksh Shrivastava, Erligheim (DE)

(21) Appl. No.: 18/990,317

(22) Filed: Dec. 20, 2024

(51) Int. Cl. H04W 24/08; H04W 56/00

(52) U.S. Cl. CPC H04W 24/08; H04W 56/0005

(57) ABSTRACT

A user equipment (UE) receives, from a network, a first bitmap that identifies a first group of measurement timing configuration (SMTC) occasions during which to perform synchronization signal block (SSB) measurements The UE performs several SSB measurements in the SMTC occasions based on the first bitmap. The UE, based on the SSB measurements, predicts a second group of SMTC occasions during which to perform future SSB measurements. The second group of SMTC occasions is different than the first group of SMTC occasions. The UE transmits, to the network, a second bitmap that identifies the second group of SMTC occasions.

### TECHNICAL FIELD

The technology generally relates to wireless communications, and more particularly, to reducing reference signal measurements in wireless networks.

### BACKGROUND

Because of the tremendous growth in the number of connected devices and the rapid increase in the user/network (NW) traffic volume, various efforts have been made to improve different aspects of the wireless communications in the next-generation radio communication systems, such as the 5^{th} generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the integration of artificial intelligence/machine learning (AI/ML) continues to expand in the 5G NR networks, it has become crucial for user equipment (UE) to accurately discern its serving and neighboring cells'AI/ML functionalities, for example, to ensure smooth handoffs, timely activation of relevant features, and efficient allocation of network resources. However, challenges emerge from dynamic network conditions, as the availability and capabilities of neighboring cells may vary due to factors such as traffic load and interference. In addition, the UE's own capabilities, internal conditions, model availability, and the inherent complexity of 5G NR networks (e.g., including integrated access and backhaul (IAB) systems) further complicate this assessment. To accurately determine the applicable functionalities of neighboring base stations (e.g., next-generation Node Bs (gNBs)) and cells, the UE has to be provided with relevant network-side information, including the appropriate timing for assessing neighboring cell functionalities and the methods for reporting this information back to the network. Reporting neighboring cell AI/ML functionality information may introduce signaling overhead that may affect the network performance.

As the demand for radio access continues to grow, however, there is a need for further improvements in wireless communications in the next-generation radio communication systems, such as improvements in the network mobility management.

### SUMMARY

In a first aspect of the present application, a UE is provided. The UE includes one or more non-transitory computer-readable media storing one or more computer-executable instructions and at least one processor coupled to the one or more non-transitory computer-readable media. The at least one processor is configured to execute the one or more computer-executable instructions to cause the UE to receive, from a network, a first bitmap that identifies a first group of measurement timing configuration (SMTC) occasions during which to perform synchronization signal block (SSB) measurements; perform several SSB measurements in the SMTC occasions based on the first bitmap; based on the SSB measurements, predict a second group of SMTC occasions during which to perform future SSB measurements, where the second group of SMTC occasions is different than the first group of SMTC occasions; and transmit, to the network, a second bitmap that identifies the second group of SMTC occasions.

In an implementation of the first aspect, the first bitmap includes several bits, each bit corresponds to an SMTC occasion in the first group of SMTC occasions, each bit takes either a first value or a second value, the first value indicates that the corresponding SMTC occasion is an SMTC occasion during which to perform SSB measurements, and the second value indicates that the corresponding SMTC occasion is an SMTC occasion during which to perform no SSB measurements.

In another implementation of the first aspect, the second bitmap includes several bits, each bit corresponds to an SMTC occasion in the second group of SMTC occasions, each bit takes either a first value or a second value, the first value indicates that the corresponding SMTC occasion is an SMTC occasion during which to perform SSB measurements, and the second value indicates that the corresponding SMTC occasion is an SMTC occasion during which to perform no SSB measurements.

In another implementation of the first aspect, transmitting the second bitmap to the network includes one of transmitting the second bitmap via radio resource control (RRC) signaling, transmitting the second bitmap via a UE assistance information (UAI) message, or transmitting the second bitmap via a medium access control element (MAC CE).

In another implementation of the first aspect, the at least one processor is further configured to execute the one or more computer-executable instructions to cause the UE to receive, from the network, a message that indicates an acceptance of the second bitmap, and in response to receiving the acceptance, perform several SSB measurements during the SMTCs identified by the second bitmap.

In another implementation of the first aspect, the at least one processor is further configured to execute the one or more computer-executable instructions to cause the UE to receive, from the network, a message indicating a rejection of the second bitmap, and in response to receiving the rejection, perform several SSB measurements during the SMTCs identified by the first bitmap.

In another implementation of the first aspect, the at least one processor is further configured to execute the one or more computer-executable instructions to cause the UE to receive, from the network, a message that includes a third bitmap that indicates a third set of one or more SMTCs during which to perform SSB measurements, the third set of SMTCs is different than the first set of SMTCs; and in response to receiving the message that includes the third bitmap, perform several SSB measurements based on the third bitmap.

In a second aspect of the present application, a UE is provided. The UE includes one or more non-transitory computer-readable media storing one or more computer-executable instructions and at least one processor coupled to the one or more non-transitory computer-readable media. The at least one processor is configured to execute the one or more computer-executable instructions to cause the UE to receive, from a network, an SMTC that includes several SMTC occasions during which to perform SSB measurements, and a first bitmap that identifies a first set of one or more SSB indices, the first set of one or more SSB indices indicates for which SSBs to perform measurements during the SMTC occasions; perform several SSB measurements in the SMTC occasions based on the first bitmap; based on the SSB measurements, predict a second set of one or more SSB indices that indicates for which SSBs to perform future measurements during the SMTC occasions; and transmit, to the network, a second bitmap that identifies the second set of one or more SSB indices.

In an implementation of the second aspect, the first bitmap includes several bits, each bit corresponds to an SSB index in the first set of SSB indices, each bit takes one of a first value or a second value, the first value indicates the corresponding SSB index is an SSB index for which to perform SSB measurements, and the second value indicates the corresponding SSB index is an SSB index for which to perform no SSB measurements.

In another implementation of the second aspect, the second bitmap includes several bits, each bit corresponds to an SSB index in the second set of SSB indices, each bit takes one of a first value or a second value, the first value indicates the corresponding SSB index is an SSB index for which to perform SSB measurements, and the second value indicates the corresponding SSB index is an SSB index for which to perform no SSB measurements.

In another implementation of the second aspect, transmitting the second bitmap to the network includes one of transmitting the second bitmap via RRC signaling, transmitting the second bitmap via a UAI message, or transmitting the second bitmap via a MAC CE.

In another implementation of the second aspect, the at least one processor is further configured to execute the one or more computer-executable instructions to cause the UE to receive from the network, a message indicating an acceptance of the second bitmap, and in response to receiving the acceptance, perform several SSB measurements based on the second bitmap.

In another implementation of the second aspect, the at least one processor is further configured to execute the one or more computer-executable instructions to cause the UE to receive, from the network, a message indicating a rejection of the second bitmap, and in response to receiving the rejection, perform several SSB measurements based on the first bitmap.

In another implementation of the second aspect, the at least one processor is further configured to execute the one or more computer-executable instructions to cause the UE to receive from the network, a message that includes a third bitmap that indicates a third set of one or more SSB indices for which to make measurements, the third set of SSB indices is different than the first set of SSB indices; and in response to receiving the message that includes the third bitmap, perform several SSB measurements based on the third bitmap.

In a third aspect of the present application, a method is provided. The method includes receiving, by a UE, from a network, a first bitmap that identifies a first group of SMTC occasions during which to perform SSB measurements; performing several SSB measurements in the first group of SMTC occasions based on the first bitmap; based on the SSB measurements, predicting a second group of SMTC occasions during which to perform future SSB measurements; and transmitting, to the network, a second bitmap that identifies the second group of SMTC occasions.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating a radio communication system, according to an example implementation of the present disclosure.

FIG. 2 illustrates an example of the SMTC and SSB indices configuration, according to an example implementation of the present disclosure.

FIG. 3 is a sequence diagram illustrating an example signaling flow for the UE reference signal measurement reduction configuration, according to an example implementation of the present disclosure.

FIG. 4 illustrates an example of the SMTC and SSB indices configuration where the SSB measurements are made for all SSB indices at each SMTC occasion, according to an example implementation of the present disclosure.

FIG. 5 illustrates an example of the SMTC and SSB indices configuration where the SSB measurements for a subset of the SSB indices are skipped at each SMTC occasion, according to an example implementation of the present disclosure.

FIG. 6 illustrates an example of the SMTC and SSB indices configuration where all SSB measurements for a subset of the SMTC occasions are skipped, according to an example implementation of the present disclosure.

FIG. 7 illustrates an example of the SMTC and SSB indices configuration where a subset of the SSB measurements for a subset of the SMTC occasions are skipped, according to an example implementation of the present disclosure.

FIG. 8 is a flowchart illustrating an example method/process performed by a UE for predicting one or more future changes to the SMTC occasions or the SSB indices that are measured during each SMTC occasion, according to an example implementation of the present disclosure.

FIG. 9 is a flowchart illustrating an example method/process performed by a UE for predicting one or more future changes to the SMTC occasions and reporting the prediction as a bitmap to the network, according to an example implementation of the present disclosure.

FIG. 10 is a flowchart illustrating an example method/process performed by a UE for predicting one or more future changes to the SSB indices configuration and reporting the prediction as a bitmap to the network, according to an example implementation of the present disclosure.

FIG. 11 is a flowchart illustrating an example method/process performed by a network node for providing several SMTCs to a UE, according to an example implementation of the present disclosure.

FIG. 12 is a flowchart illustrating an example method/process performed by a network node for providing several SSB indices configurations to a UE, according to an example implementation of the present disclosure.

FIG. 13 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), and/or LTE-A Pro. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR is to support flexible configurations for accommodating various next generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it should also be noted that in a transmission time interval (TTI) of a single NR frame, DL transmission period, a guard period, and UL transmission data may at least be included, where the respective portions of the DL transmission data, the guard period, and the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in a radio resource control connected (RRC_CONNECTED) state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

According to one aspect of the present disclosure, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

It should be noted that the term transmission reception point (TRP) in the present disclosure may be replaced by ‘beam’ or ‘panel’. It should also be noted that the term ‘overlap’ may refer to time domain overlapping or frequency domain overlapping.

Examples of some selected terms in the present disclosure are provided as follows.

Antenna Panel: It may be assumed that an antenna panel is an operational unit for controlling a transmit spatial filter/beam. An antenna panel typically includes several antenna elements. A beam may be formed by an antenna panel and in order to form two beams simultaneously, two antenna panels are needed. Such simultaneous beamforming from multiple antenna panels is subject to the UE capability. A similar definition for “antenna panel” may be possible by applying spatial receiving filtering characteristics.

BWP: A subset of the total cell bandwidth of a cell is referred to as a bandwidth part (BWP), and bandwidth adaptation (BA) is achieved by configuring the UE with BWP(s) and telling the UE which of the configured BWPs is currently the active one. To enable BA on the PCell, the gNB configures the UE with UL and DL BWP(s). To enable BA on the SCells in case of the CA, the gNB configures the UE at least with the DL BWP(s) (e.g., there may be no BWP in the UL). For the PCell, the initial BWP is the BWP used for an initial access. For the SCell(s), the initial BWP is the BWP configured for the UE to first operate at the SCell activation. The UE may be configured with a first active uplink BWP, for example, by a firstActiveUplinkBWP IE. If the first active uplink BWP is configured for an SpCell, the firstActiveUplinkBWP information element (IE) field may contain the ID of the UL BWP to be activated upon performing the RRC (re-)configuration. If the firstActiveUplinkBWP IE field is absent, the RRC (re-)configuration may not impose a BWP switch. If the first active uplink BWP is configured for an SCell, the firstActiveUplinkBWP IE field may contain the ID of the UL BWP to be used upon the MAC-activation of an SCell.

TCI state: A transmission configuration indication (TCI) state may contain parameters for configuring a Quasi-CoLocation (QCL) relationship between one or more reference signals and a target reference signal set. For example, a target reference signal set may be the Demodulation Reference Signal (DM-RS) ports of the Physical Downlink Shared Channel (PDSCH), Physical Downlink Control Channel (PDCCH), PUCCH or Physical Uplink Shared Channel (PUSCH). The one or more reference signals may include UL or DL reference signals. In NR Rel-15/16, the TCI state is used for DL QCL indication whereas spatial relation information is used for providing UL spatial transmission filter information for UL signal(s) or UL channel(s). Here, a TCI state may refer to information provided similar to spatial relation information, which could be used for UL transmission. In other words, from the UL perspective, a TCI state provides a UL beam information which may provide the information for a relationship between a UL transmission and a DL (or a UL) reference signal (e.g., Channel State Information Reference Signal (CSI-RS), Synchronization Signal Block (SSB), Sounding Reference Signal (SRS), Phase Tracking Reference signal (PTRS)).

A UE may be configured with a list including up to M TCI state configurations, where each TCI state may contain parameters for configuring at least one QCL relationship between one or more downlink reference signals and the DM-RS ports of the PDSCH, the DM-RS port of PDCCH, or the CSI-RS port(s) of a CSI-RS resource. The QCL types corresponding to each DL RS may be given, for example, by the higher layer (e.g., RRC layer), parameters for the at least one RS and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial reception (Rx) parameter}

Furthermore, a UE may be configured with a TCI state configuration that contains parameters for determining a UL transmission (TX) spatial filter for the UL transmissions. More specifically, when signals transmitted from different antenna ports share channels with similar properties, the antenna ports are said to be QCL signals. Basically, the QCL concept is introduced to help the UE with a precise channel estimation, frequency offset error estimation, and synchronization procedures.

Panel: The UE panel information may be derived from the TCI state/UL beam indication information or from the network signaling.

Beam: The term “beam” may be replaced with spatial filter. For example, when a UE reports a preferred gNB TX beam, the UE is essentially selecting a spatial filter used by the gNB. The term “beam information” may be used to provide information about which beam/spatial filter has been used/selected.

Multi-TRP: Multi-TRP is a feature that enables a BS (e.g., a gNB) to communicate with a UE using more than one TRP, for example, to ensure reliability. Moreover, NR supports same data stream(s) received from multiple TRPs at least with an ideal backhaul, and different NR-PDSCH data streams received from multiple TRPs with both ideal and non-ideal backhauls. An ideal backhaul may allow single Downlink Control Information (DCI) to be transmitted via a PDCCH from one TRP to schedule data transmission (or information) to/from multiple TRPs (may also be referred to as single-DCI based multi-TRP/panel transmission). On the other hand, a non-ideal backhaul may require multiple DCIs to be carried in the PDCCH(s) to schedule data transmission (or information) corresponding to each TRP (may also be referred to as multi-DCI based multi-TRP/panel transmission). To enhance reliability for the system, at least one multi-TRP scheme may be applied to at least one channel/reference signal, for example, a multi-TRP based PDSCH operation, a multi-TRP based PDCCH operation, a multi-TRP based PUCCH operation, and/or a multi-TRP based PUSCH operation.

TDM based PDCCH repetition: For example, two PDCCHs may be linked together for the repetition of the same DCI format, the same DCI payload, the same number of CCEs, and/or the same number of candidates for each AL. The two PDCCHs may be in two search spaces associated with two Control Resource Sets (CORESETs).

TDM based PDSCH repetition: PDSCH repetition refers to multiple PDSCHs that have the same TB and are associated with different TRPs. Slot-based PDSCH repetition corresponds to scheduling each repetitive PDSCH in individual slots. Non-slot-based PDSCH repetition corresponds to scheduling multiple repetitive PDSCHs within the same slot.

TDM based PUCCH repetition: PUCCH repetition refers to multiple PUCCHs with the same Uplink Control Information (UCI) content but corresponding to different beams. There are two types of PUCCH repetitions: inter-slot based PUCCH repetition and intra-slot based PUCCH repetition, which are categorized according to their timing and relate to all PUCCH formats. Inter-slot based PUCCH transmission corresponds to transmitting each repetitive PUCCH in individual slots. Intra-slot based PUCCH transmission corresponds to transmitting each repetitive PUCCH in individual slots and transmitting multiple repetitive PDSCHs within the same slot.

TDM based PUSCH repetition: PUSCH repetition refers to multiple PUSCHs with the same TB but corresponding to different TRPs. Slot-based PUSCH repetition corresponds to scheduling each repetitive PUSCH in an individual slot. Non-slot-based PUSCH repetition corresponds to scheduling multiple repetitive PUSCHs within the same slot.

Frequency Division Multiplexing (FDM) based PDSCH repetition: Multiple PDSCHs with the same TB but corresponding to two TCI states. These PDSCHs are allocated to non-overlapping frequency resources within a slot.

Multi-DCI based PDSCH scheme: Two PDCCHs from separate search spaces associated with different CORESET pool indexes that schedule the corresponding PDSCHs.

Single Frequency Network (SFN) based PDCCH scheme: A CORESET is associated with two different beams.

SFN based PDSCH scheme: A PDSCH is associated with two different beams.

Measurement objects: A list of objects on which the UE shall perform the measurements. For intra-frequency and inter-frequency measurements, a measurement object indicates the frequency/time location and subcarrier spacing of the reference signals to be measured. Associated with this measurement object, the network may configure a list of cell specific offsets, a list of exclude-listed cells and a list of allow-listed cells. The exclude-listed cells are not applicable in event evaluation or measurement reporting. The allow-listed cells are the only cells that are applicable in event evaluation or measurement reporting.

Unified TCI framework: To facilitate more efficient (lower latency and overhead) DL/UL beam management to support a larger number of configured TCI states, a unified TCI framework for beam indication may result in some benefits of low complexity and simplified controlling mechanisms. More specifically, through the unified indication, the DL or UL channels/signals may share the same indicated TCI state to reduce the signaling overhead, and different channels and/or reference signals may share similar channel properties. The unified indication may be used to indicate a common TCI state for the DL channels (e.g., including a PDCCH, PDSCH, and/or DL reference signal), a common TCI state for the UL channels (e.g., including a PUCCH, PUSCH, and/or UL reference signal), and/or a common TCI state for both DL and UL channels. The unified indication for a common TCI state for the DL channels may be referred to as a “DL TCI state” or a “DL only”. The unified indication for a common TCI state for the UL channels may be referred to as a “UL TCI state” or a “UL only”. The unified indication for a common TCI state for both DL and UL channels may be referred to as a “joint TCI state” or a “joint indication”. The “DL only” and “UL only” may also be referred to as a “separate TCI state,” as opposed to the “joint TCI state”.

Unified TCI states may be indicated through an RRC message, a Medium Access Control Element (MAC CE), and/or the DCI. For example, the RRC message may indicate whether the unified framework is enabled. The MAC CE may further indicate where to apply the unified TCI framework. In addition, the DCI may also include information for the unified TCI states to explicitly indicate the TCI states to the UE. In particular, the information contained in the MAC CE may refer to a serving cell index, a DL BWP index, a UL BWP index, the number of TCI states included in each TCI codepoint, transmission direction, and/or a TCI state index. However, when the unified TCI framework is applied to multiple TRPs, there is no further information to link the specific TCI states to the specific TRPs. Consequently, since multiple TRPs may correspond to different schemes, such as a TDM scheme, an FDM scheme, a multi-DCI scheme, and an SFN scheme, some potential impact may need to be considered when applying the unified TCI framework (e.g., including the DL only, UL only, and/or joint indication) to different schemes for multiple TRPs. The following cases are listed as possible scenarios where the unified TCI framework may be applied. Furthermore, the listed scenarios may correspond to an intra-cell or an inter-cell multi-TRP scheme. It should be noted that the disclosed implementations may include one or more of the following scenarios:
Single DCI based TDM PDSCH repetition;
Single DCI based FDM PDSCH repetition;
Multi-DCI based PDSCH;
TDM PDCCH repetition;
FDM PDCCH repetition;
Single DCI based TDM PUSCH repetition;
TDM PUCCH repetition;
SFN based PDCCH scheme;
SFN based PDSCH scheme;
Single DCI based FDM PUSCH repetition;
Multi-DCI based PUSCH;
FDM PUCCH repetition;
SFN based PUSCH scheme; and
SFN based PUCCH scheme.

When the unified TCI framework is applied to at least one multi-TRP scheme, some changes may be needed. The changes may include the association between the unified indication and at least one TRP, the mapping order of the indicated TCI states, the association between the unified indication and the respective channel, and/or the method of signaling for each channel. In the present disclosure, implementations for applying the unified TCI framework to the multi-TRP scheme are disclosed hereinafter.

The 3GPP (e.g., as indicated in Release 18, study item (SI) on artificial intelligence/machine learning (AI/ML) for air interface) has identified the following scopes: (i) identify use cases and scenarios where the AI/ML may be effectively applied within the 3GPP-defined network architectures and protocols, (ii) study the integration of the AI/ML algorithms into the network functions, protocols, and management systems to enable intelligent decision-making and automation, and (iii) evaluate the impact of the AI/ML on the network scalability, reliability, energy efficiency, spectral efficiency, and quality of service.

For an AI/ML based beam management (BM) use case, the following two use cases may be selected, as the representative AI/ML sub-use cases. The first use case (BM-Case1) may include spatial-domain downlink beam prediction for a first set of beams (e.g., Set A of beams) based on measurement results of a second set of beams (e.g., Set B of beams).

For the BM-Case1, the following alternatives may be considered. The AI/ML model training and inference may be done either at the network side or at the UE side. Set A and Set B may be different (e.g., Set B may not be a subset of Set A) or Set B may be a subset of Set A. It should be noted that Set A is for DL beam prediction. The codebook construction of Set A and Set B may be later defined.

The AI/ML model input may consider the following alternatives: (1) The layer 1reference signal reception power (L1-RSRP) measurement based on Set B, the L1-RSRP measurement based on Set B and assistance information, the channel impulse response (CIR) based on Set B, or the L1-RSRP measurement based on Set B and the corresponding DL Tx and/or Rx beam ID.

The second use case (BM-Case2) may include temporal downlink beam prediction for Set A of beams based on the historic measurement results of Set B of beams. For the BM-Case2, the following alternatives may be considered. The AI/ML model training and inference may be done either at the network side or at the UE side. Set A and Set B of beams may be different (e.g., Set B may not be a subset of Set A), Set B may be a subset of Set A (e.g., Set A and Set B may not be the same), or Set A and Set B are the same.

The AI/ML model input may consider measurement results of K (K≥1) latest measurement instances with the following alternatives: (1) Only the L1-RSRP measurements based on Set B, (2) The L1-RSRP measurements based on Set B and assistance information, or (3) The L1-RSRP measurements based on Set B and the corresponding DL Tx and/or Rx beam identification (ID). F predictions for F future time instances may be obtained based on the output of the AI/ML model, where each prediction is for each time instance. F may, at least be equal to 1.

Based on the parameters like report of the predicted top-K beam IDs, report of the predicted and/or actual/measured L1-RSRPs associated with the predicted top-K beams, report of the quantities indicating the confidence level of predictions for the top-K beams (e.g., the standard deviation of the predicted L1-RSRPs or statistics of the past RSRP measurements as a proxy for the confidence level of the predictions) and other related parameters like KPIs, the AI/ML model may provide output in the form of F (f1,f2 . . . fn) predictions for T(t1,t2, . . . tn) future time instances. The prediction may reflect predicted beams and their corresponding configurations.

RAN work group 2 (RAN WG2 or RAN2), during phase 1 discussions, has defined different functionality types for AI/ML functionalities. A functionality may refer to an AI/ML-enabled feature, or feature group, facilitated by a configuration. A functionality, in the context of AI/ML-enabled 5G NR and beyond communication systems, may refer to a specific feature, or a collection of related features, that is enabled by artificial intelligence or machine learning capabilities. These functionalities are supported and managed through configurations, which are sets of parameters or instructions that dictate how the AI/ML enabled a 5G NR (or beyond) system should operate. Essentially, a configuration ensures that the functionality works correctly by providing the necessary settings and data for the AI/ML processes including the life cycle Management (LCM) of the AI/ML model/functionality to work effectively.

Technical document TR 38.843 (Study on Artificial Intelligence (AI)/Machine Learning (ML) for NR air interface) provided the following definitions for the AI/ML models:

AI/ML-enabled Feature: Refers to a Feature where AI/ML may be used.

AI/ML Model: A data driven algorithm that applies AI/ML techniques to generate a set of outputs based on a set of inputs.

AI/ML model Inference: A process of using a trained AI/ML model to produce a set of outputs based on a set of inputs.

Model activation: Enable an AI/ML model for a specific AI/ML-enabled feature.

Model deactivation: Disable an AI/ML model for a specific AI/ML-enabled feature.

Two-sided (AI/ML) model: A paired AI/ML Model(s) over which joint inference is performed, where joint inference includes AI/ML Inference whose inference is performed jointly across the UE and the network, i.e., the first part of inference is first performed by UE and then the remaining part is performed by gNB, or vice versa.

UE-side (AI/ML) model: An AI/ML model whose inference is performed entirely at the UE.

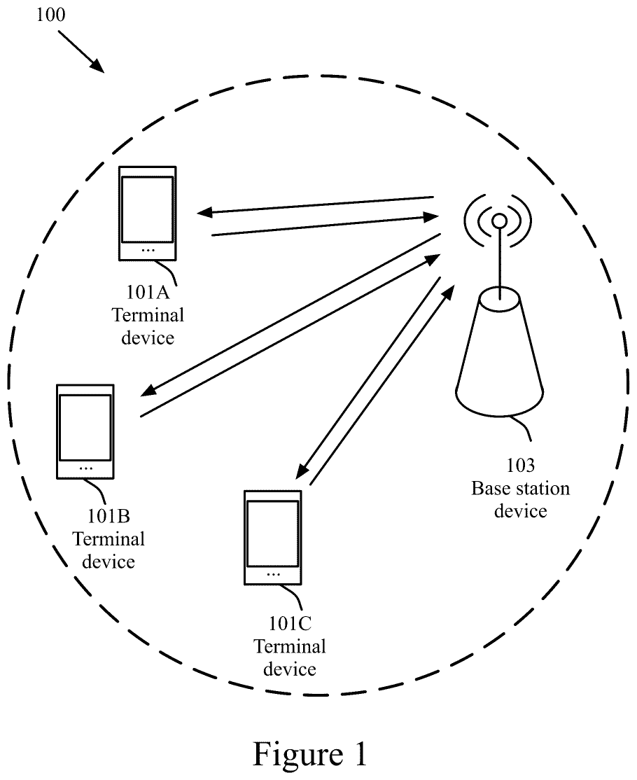

FIG. 1 is a schematic diagram illustrating a radio communication system, according to an example implementation of the present disclosure. In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

BS 103 may include one or more transmission/reception devices. When BS 103 is configured with multiple transmission/reception devices, each of the multiple transmission/reception devices may be arranged at a different position. A transmission/reception device may include a transmission device and/or a reception device.

BS 103 may serve radio communication and provide one or more cells. A cell is defined in this disclosure, as a set of resources used for a wireless communication. A cell may include one or both of a downlink component carrier and an uplink component carrier. A serving cell may include a downlink component carrier and two or more uplink component carriers.

The BS 103, or another network entity, such as a location management function (LMF) server, in some embodiments, may provide multiple sets of configurations to the UE 101A-101C for a given AI/ML functionality. The BS 103, or the other network node, may provide a mechanism to change the configuration sets based on changes in the UE's environment and/or additional conditions.

In a wireless communication system, the RRC configuration process may be used for setting up, maintaining, and modifying the radio connection between the UE and the BS (e.g., a gNB) in the 5G/5G-Advanced (5G-A) networks. The BS 103 or the network entity, may send an RRC message to a UE 101A-101C to configure at least one of the configuration parameters or features of a configuration set. This RRC message may be, for example, RRCSetup, RRCReconfiguration, RRCResume, RRCRelease, or other downlink messages generated by the BS 103 or another network entity. The BS 103 and/or the other network entities are considered as components of the network. In the following discussions, the term network, or network node, refers to any network entity, such as, BS (e.g., gNB), LMF server, etc., and the BS 103 may be used as an example of such network node.

The term “configuration,” herein, may refer to the arrangement and specification of components, settings, or parameters within a system or device, as defined by the applicable agreements, standards, or specifications. The term configuration may encompass the established setup and customization of elements necessary to ensure compliance with contractual obligations, operational requirements, and performance criteria.

### Reduction of UE's Reference Signal Measurements

The AI/ML Mobility study item (RP-240082) considers the following aspects:
AI/ML based radio resource management (RRM) measurement and event prediction
   Cell-level measurement prediction including intra and inter-frequency ((UE side and the NW side model) [RAN work group 2 (RAN WG2 or RAN2)]
      Inter-cell Beam-level measurement prediction for L3 Mobility (UE side and NW side model) [RAN2]
   Handover (HO) failure/Radio Link Failure (RLF) prediction (UE side model) [RAN2]
   Measurement events prediction (UE side model) [RAN2]
Study the need/benefits of any other UE assistance information for the network side model [RAN2]
The evaluation of the AI/ML aided mobility benefits should consider HO performance KPIs, for example, Ping-pong HO, HO failure (HOF)/RLF, Time of stay, Handover interruption, prediction accuracy, and measurement reduction) etc., and complexity tradeoffs [RAN2].

In the technical report TR 38.744, the following study goals have been described. The first study goal is to reduce measurement efforts in temporal, spatial, or frequency domain, by using predicted measurements. The second study goal is to improve the handover performance (e.g., Ping-pong HO, HOF/RLF, short time of stay, Handover interruption).

Measurement reduction rate for an intra-frequency scenario in the temporal domain (referred to as MRRT) is defined by assuming the same length of measurement time instances, as follows:

MRRT=skipped measurement time instances/total measurement time instances.

Measurement reduction rate for an intra-frequency scenario in the spatial domain (also referred to as MRRS) is defined as follows:

MRRS=skipped beams to be measured/total beams to be measured.

The following agreements have also been made in the RAN2 meeting #127 (RAN2 #127). Both direct and indirect measurement event predictions are allowed. Companies should indicate what method and what inputs they have used. Output for the indirect method may include predicted signal to interference and noise ratio (SINR). Based on the predicted SINR, the time instance an RLF occurs may be determined without further AI/ML models. Output for the direct method may include the probability of an RLF within a time window.

The following agreements have also been made in the RAN2 meeting #128 (RAN2 #128). The prediction accuracy for intra-frequency temporal domain case B will be reduced as the MRRT increases. For temporal domain case B, with the same MRRT, different skipping patterns may provide different prediction performances. Companies may report the adopted skipping pattern when providing the simulation results.

The currently available specifications in the 5G standard (mainly technical specification TS 38.331) provide mechanisms for the network to configure the UEs to measure reference signals (such as SSB) in a periodical (or event triggered) manner. Some of the important configurations and definitions (technical specification TS 38.331) are listed below.

SSB-periodicityServingCell: The SSB periodicity in milliseconds (ms) for the rate matching purpose. If the field is absent, the UE applies the value ms5.

SSB-PositionsInBurst: For operation in the licensed spectrum, indicates the time domain positions of the transmitted SS-blocks in a half frame with SSB/physical broadcast channel (SS/PBCH) blocks.

SSB-MTC (SMTC): measurement timing configurations, for example, timing occasions at which the UE measures SSBs.

SSB-ToMeasure is used to configure a pattern of SSBs. For operation with shared spectrum channel access in FR1, only mediumBitmap is used, and for FR2-2, longBitmap is used.
Provided in System Information Block Type 2 (SIB2 ) or RRC under ssb-ConfigMobility SSB-ToMeasure::=CHOICE{
shortBitmap BIT STRING (SIZE (4)),
mediumBitmap BIT STRING (SIZE (8)),
longBitmap BIT STRING (SIZE (64))
   }

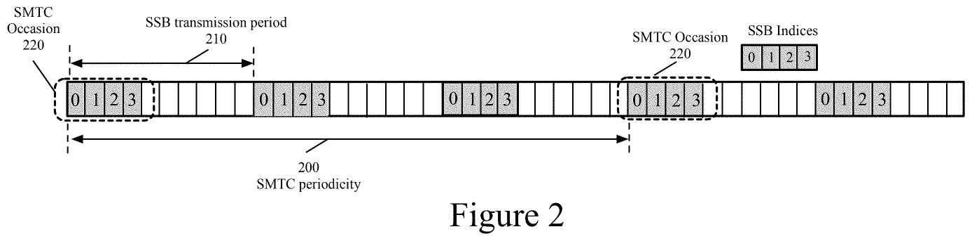

FIG. 2 illustrates an example of the SMTC and SSB indices configuration, according to an example implementation of the present disclosure. The network may be transmitting SSB signals periodically (as shown by 210), but may configure the UE to measure only some of the SSB signals. As shown in the example of FIG. 2, the UE may only measure the SSB signals with the SMTC periodicity 200, as configured by the network (e.g., by a network node). The network may also configure the UE to only measure a subset of the available SSB indices, using, for example, the SSB-ToMeasure Information Element. In the example of FIG. 2, the UE may be configured to measure all SSB indices 0, 1, 2, and 3 at each SMTC occasion 220 (as shown by dashed lines).

When the UE is configured with an AI/ML functionality for the purpose of mobility (measurement predictions, handovers, etc.), the UE may utilize the UE-side AI/ML models (as configured by the network) to generate measurement predictions. The AI/ML model/functionality may provide the information to the UE that indicates on which time instances the UE must perform the measurements to be provided as inputs to the AI/ML model. This may be configured by the network, for example, with a minimum number of measurements to be performed by the UE, or with an MRRT value of, for example, 50% measurement reduction.

Further, the AI/ML model/functionality may also provide the information that indicates on which time instances the UE may skip performing the measurements, which may be due to, for example, the AI/ML functionality that provides the predicted measurements for those time instances. In some embodiments, the UE may utilize the information provided by the AI/ML model/functionality to coordinate with the network to reduce the number of measurements to be made by the UE. The network node may be aware of which time/frequency resources are monitored by the UE for the measurements. The network may also utilize the measurement reduction information to train/operate the network node's own AI/ML models (the network side models) for AI/ML functionality for mobility. This information, when available to the network, may be used to potentially reduce the number of SSB transmissions or increase the number of data transmission opportunities.

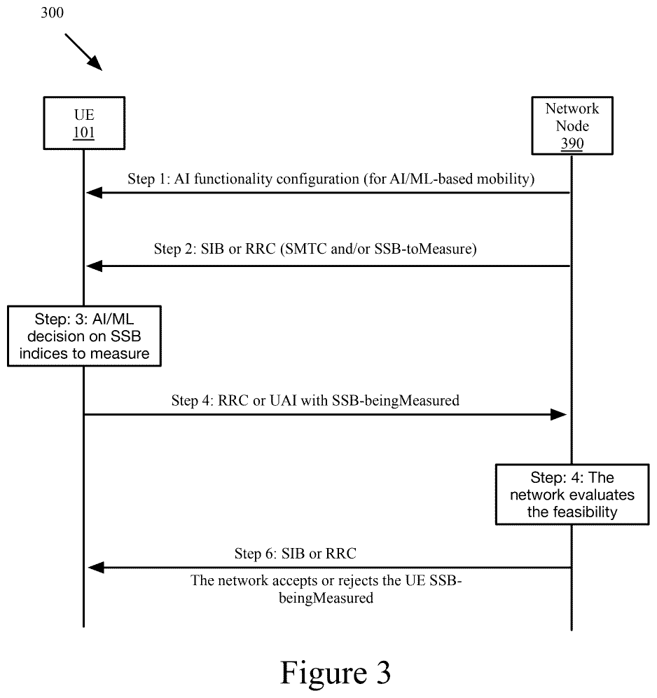

FIG. 3 is a sequence diagram 300 illustrating an example signaling flow for the UE reference signal measurement reduction configuration, according to an example implementation of the present disclosure. The wireless communication system may include, for example, a 3GPP network, such as, the 5G/5G-A or the 6^{th} generation (6G) NR system. The UE 101 may be any of the UEs 101A-101C and the network node 390 may be the BS 103, as shown in FIG. 1, or any other network entity, for example, network/UE relays, etc.

Step 1 and step 2 of the sequence diagram 300 may be interchanged. The network node 390 may configure the UE in step 1 with the AI/ML functionality, which may be specific to the mobility-related aspects. For example, the network node 390 may provide the UE 101 with information, such as network-side conditions for beam management. The network node 390 may also configure the UE-side model to be utilized for the purpose of AI/ML-based UE mobility. The UE-side AI/ML functionality may require explicit activation by the network node 390 to provide predicted measurement results.

During step 1, the network node 390 may configure the UE 101 with appropriate KPIs to be monitored for the AI/ML functionality. For example, the network node 390 may provide one or more KPI thresholds, which may result in (de)activation of the AI/ML functionality. For instance, the AI/ML functionality may be deactivated if the UE 101 (possibly together with the network node 390) determines that the measurement predictions of the AI/ML functionality is below a certain configured threshold, for example, 80%.

In step 2, the network may provide the necessary configurations to the UE for performing the measurements (e.g., SSB). This may involve reception of the relevant SIB(s) (e.g. SIB2) by the UE, or RRC signaling between the network and the UE. In this step, the network may provide the SSB-MTC configurations, which may indicate the occasions for the UE to perform the measurements. This step may also involve an indication of SSB-ToMeasure (legacy), with which the UE may be configured with the exact SSB indices or signals to measure. The SMTC and SSB-ToMeasure and other related configurations may be utilized as inputs to the AI/ML mobility functionality.

Before step 3, the UE 101 may be actively performing the measurements, as configured by the network node 390. The activated AI/ML mobility functionality may utilize the actual (legacy) measurement results obtained by the measurement procedures, as required, for example, as inputs to the AI/ML model. In step 3, the AI/ML functionality may provide predicted measurements as output. Further, the AI/ML functionality may provide information on future time indices (e.g., measurement occasions) for which the AI/ML functionality may provide predicted measurements. This information may be combined with the exact SSB indices for which the AI/ML functionality provides measurement predictions. The AI/ML functionality may also provide output information on which future measurement occasions, and for which SSB indices, the AI/ML model may require inputs, for example, through performing legacy measurements.

In step 4, the UE 101 may utilize the output information provided by the AI/ML functionality in step 3, on which future measurement instances, or SSB indices, may require actual/legacy measurements as inputs, or which future measurement instances/SSB indices may have predicted results available. The future measurement instances or SSB indices, where measurements are needed as an input, may require that the UE performs the legacy measurement procedure. The future measurement instances or SSB indices, where predictions are expected, are possible candidates for the UE to skip the measurements. The UE 101 may provide this information to the network node 390, for example, by using a novel IE, such as SSB-beingMeasured IE. The SSB-beingMeasured IE may be a sub-information element in an RRC message, such as the RRC Reconfiguration Complete message, or in a UE Assistance Information (UAI). The SSB-beingMeasured may be provided by the UE as a response to the SSB-toMeasure (legacy) Information Element.

In step 4, after receiving the SSB-beingMeasured IE from the UE 101, the network node 390 may evaluate the feasibility of the measurement procedure because of the resulting measurement occasions for the UE. The network node 390 may accept or decline the SSB-beingMeasured from the UE 101, or may alternatively modify this IE. For instance, the network may utilize its own AI/ML models to evaluate the accuracy of UE measurements or measurement predictions as a result of applying the measurement reductions.

In step 6, the network decision may be provided to the UE 101 as a response to receiving the SSB-beingMeasured IE. Based on this, the UE 101 may perform measurements on the resulting measurement occasions. The network node 390 may indicate its decision via SSB-toMeasure (legacy) or through a new information element, for example, SSB-toMeasure_decision. The network node 390 may send its decision to the UE 101 by, for example, sending a SIB (e.g. SIB2) to the UE or by RRC signaling between the network and the UE.

### The UE Aspects of Step 3

In some embodiments, the AI/ML functionality activated at the UE may decide, in step 3 of FIG. 3, to skip some measurement instances or skip measuring certain SSB indices based on one or more of the following. The UE may measure internal or network-configured KPIs for the AI/ML functionality. For example, the UE may compare the accuracy of predicted measurements with corresponding accuracy thresholds. The UE may also be informed of the accuracy by the network, for example, based on the previously reported measurements and the related predicted measurements by the UE.

Depending on the level of accuracy achieved/required, the UE may decide to modify (increase or decrease) the number of measurements to be made or skipped. For example, this may be done per SSB index, or it may be averaged over all measured SSBs over a certain period. The KPIs, for example, may be maintained over an observation period related to the upcoming prediction window(s).

Depending on the required measurement reduction rate (MRRT or MRRS), and/or the required prediction accuracy, the UE-side model may choose the appropriate measurement occasions/windows/SSB indices to be skipped, and may inform the radio layers. This information may be used by, for example, the UE RRC layer to inform the network, or may be provided to the lower layers for performing/skipping appropriate measurements.

In some embodiments, the UE AI/ML mobility functionality may also determine the measurement occasions/SSB indices to be used/skipped based on the perceived network load. This may be, for example, based on the number of retransmissions over a certain period. The data retransmissions may be indicative of the Quality of Service experienced. In data retransmission, for example, may be the averaged throughput over a time window that may be configured by the network node. The UE AI/ML mobility functionality may determine the appropriate measurement occasions/SSB indices to be used/skipped based on the predicted mobility related events. For example, if the UE AI/ML mobility functionality predicts a handover or radio link failure event, the number of measurements to be performed may be increased (or the skipped measurements are decreased).

### UE-Centered Signaling of Step 4

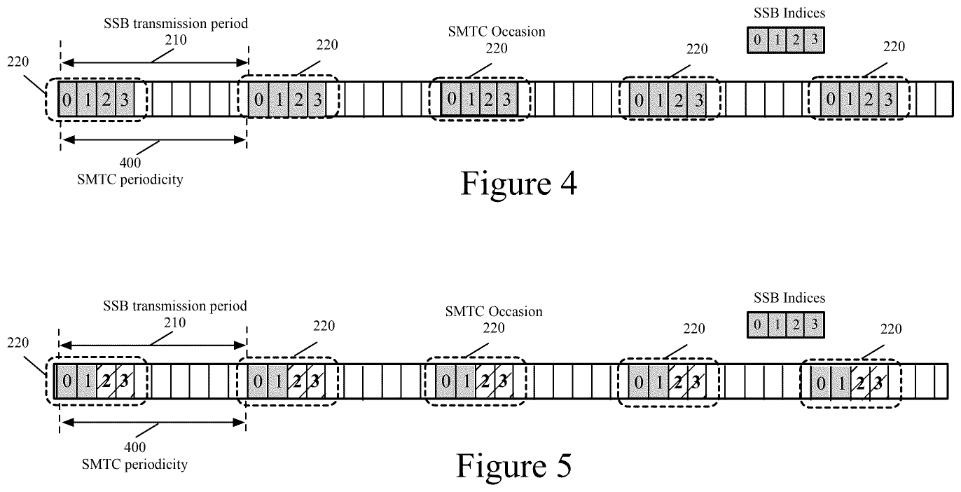

The SSB-beingMeasured provided by the UE 101 to the network node 390 may be formulated as follows. FIG. 4 illustrates an example of the SMTC and SSB indices configuration where SSB measurements are made for all SSB indices at each SMTC occasion, according to an example implementation of the present disclosure. In the example of FIG. 4, the network node may have indicated with the SSB-toMeasure IE that the UE has to measure all four SSB indices (0,1,2,3) in each SMTC period as shown in FIG. 4. This may be indicated by the network node 390 to the UE 101 by setting all bits to 1 as follows.
SSB-ToMeasure::=CHOICE{
   shortbitmap BIT SRING (SIZE (4)), [set to 1111]
}

As shown in FIG. 4, the UE performs all SSB measurements according to the SMTC configuration that the UE 101 receives from the network node 390 in step 2 of FIG. 3. When the AI/ML functionality of the UE decides to skip some (e.g., 50%) of the SSB measurements, the UE may have the following options. In option 1, the measurement reduction may be achieved by skipping some of the SSB indices. In this option, the UE 101 may decide, for example, to skip measuring 2 of the 4 SSB indices provided in the SSB-toMeasure IE received from the network node 390 in step 2.

FIG. 5 illustrates an example of the SMTC and SSB indices configuration where the SSB measurements for a subset of the SSB indices are skipped at each SMTC occasion, according to an example implementation of the present disclosure. For example, the UE may skip SSB indices 2 and 3 in each SMTC occasion as shown in FIG. 5.

In the example of FIG. 5, the UE may use a novel construct SSB-beingMeasured IE to report the SSBs that are being measured as follows. The UE 101 may send the network node 390 a bitmap to indicate at which SSBs indices the measurements are/are not performed. For example, the indices for which the bitmap is set to 1 may indicate to the network that the UE performs measurement, and the indices set to 0 may indicate that the UE skips measurement, as shown in the following bitmap. The network may also infer that the UE produces predicted measurements for the indices marked with 0s.
SSB-BeingMeasured::=Choice{
   shortBitmap_SSB_Indices BIT STRING (SIZE (4)), [set to 1100]
}

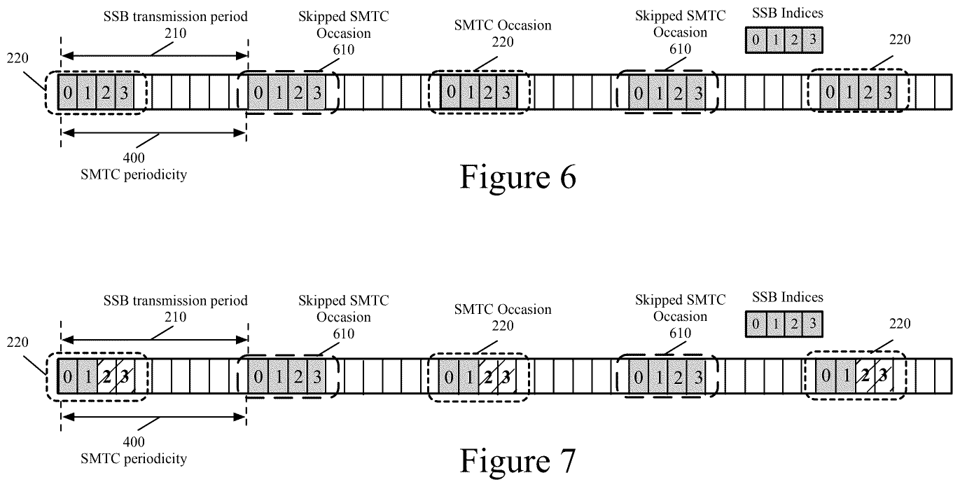

In option 2, the measurement reduction may be achieved by skipping some of the SMTC windows. In this option, the UE 101 may decide, for example, to skip all SSB indices on every alternating SMTC window. FIG. 6 illustrates an example of the SMTC and SSB indices configuration where all SSB measurements for a subset of the SMTC occasions are skipped, according to an example implementation of the present disclosure. In this option, the UE may inform the network with a similar bitmap as the SSB-beingMeasured IE, with each of the bits representing, for example, a future SMTC measurement window. For example, when the bit is set, the UE may measure all SSB indices within the SMTC window, and when the bit is reset, skip all SSB indices within the corresponding SMTC window. Similar to SSB-beingMeasured IE, the bitmaps for SMTC-beingMeasured IE may indicate whether or not a certain SMTC window involves the UE measuring the SSB indices within it.
SMTC-BeingMeasured::=CHOICE{
   shortBitMap_SMTC_Indices BIT STRING (SIZE (4)), [set to 1010]
}

In option 3, the measurement reduction may be achieved by skipping some of the SMTC windows and skipping some of the SSB indices in the SMTC occasions that are not skipped. FIG. 7 illustrates an example of the SMTC and SSB indices configuration where a subset of the SSB measurements for a subset of the SMTC occasions are skipped, according to an example implementation of the present disclosure. In this option, the UE may inform the network with two bitmaps. In one bitmap, for example, the logical 1 bits may represent a future SMTC measurement window, and in the other bitmap the logical 1 bits may represent the SSB indices for which the UE may make an SSB measurement. In the example of FIG. 7, every other SMTC occasion may be skipped (as shown by the skipped SMTC occasions 610). Furthermore, in the SMTC occasions 220 where the SSB measurements are made, only the SSBs corresponding to the indices 0 and 1 are measured and the SSBs corresponding to the indices 2 and 3 are skipped.

In some embodiments, the UE may report multiple bitmaps under the SSB-beingMeasured IE, which may be used by the network to interpret on which measurement occasions the UE expects to perform (or skip) measurements. For example, a short bitmap may indicate the SSB indices to be measured within a certain measurement window, and a longer bitmap may indicate whether or not the skipping pattern is applied for the corresponding measurement window (or vice versa).

In some embodiments, the UE or the network may combine bitmaps of varied lengths (e.g., differing number of bits) to indicate information on SSB indices or SMTC windows to be measured or skipped. For example, when the UE reports both the SSB-beingMeasured IE and the SMTC-beingMeasured IE to the network, the network may combine the information provided by the UE to derive the measurement skipping (or performing) pattern.

For example, when the following is configured, the network may interpret that the UE measures the first two SSB indices (because it is set to 1100) for any SMTC window for which the UE has set the SMTC index to 1 (set to 1010, alternate SMTC windows in this example).
SSB-BeingMeasured::=CHOICE{
   ShortBitMap_SSB_Indices BIT STRING (SIZE (4)), [set to 1100]
}
SMTC-BeingMeasured::=CHOICE{
   ShortBitMap_SMTC_Indices BIT STRING (SIZE (4)), [set to 1010]
}

The SSB-beingMeasured and/or SMTC-beingMeasured provided by the UE may be associated with relevant validity timers for the corresponding AI/ML functionality. For example, the skipping pattern provided by the UE may be valid for a finite duration (e.g., 1 second) or measured in terms of number frames or number of slots. After the expiry of the timer, it may be required that the UE falls back to the primary (or legacy) measurement configuration, which may require that the UE performs measurements on all occasions/SSB indices as configured by the network. In alternative examples, the measurement skipping may be indicated by the length of the bitmap reported by the UE under the SSB-beingMeasured IE and/or the SMTC-beingMeasured IE. The duration of the validity may also be indicated explicitly by the UE.

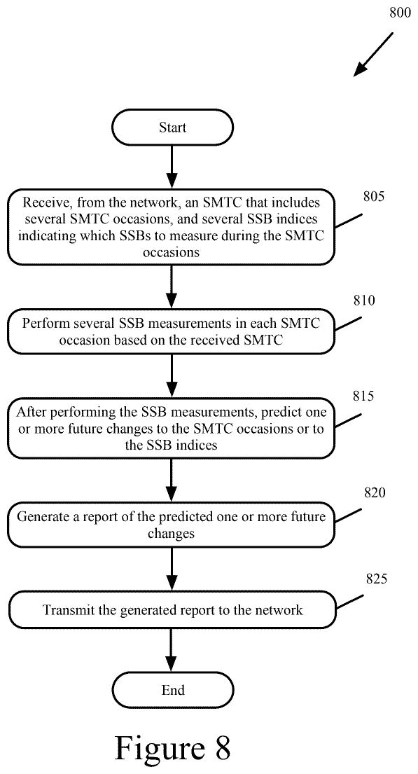

FIG. 8 is a flowchart illustrating an example method/process 800 performed by a UE for predicting one or more future changes to the SMTC occasions or the SSB indices that are measured during each SMTC occasion, according to an example implementation of the present disclosure. The process 800 may be performed by at least one processor of a UE 101A-101C, shown in FIG. 1.

The process 800 may receive (at block 805), from a network node, an SMTC that includes several SMTC occasions, and several SSB indices that may indicate which SSBs to measure during the SMTC occasions. For example, the process 800 may receive several SMTC occasions, and several SSB indices as discussed above with reference to FIG. 4 and steps 1 and 2 of FIG. 3. As shown in the example of FIG. 4, several SSBs corresponding to the indices 0, 1, 2, and 3 are transmitted in each SSB transmission period 210 and several SMTC occasions 220 are identified for measuring the SSBs.

The process 800 may perform (at block 810) SSB measurements in each SMTC occasion based on the received SMTC. In the example of FIG. 4, the SSBs corresponding to all indices 0, 1, 2, and 3 may be measured by the UE in each SMTC occasion 220.

After performing the SSB measurements, the process 800 may predict (at block 820) one or more future changes to the SMTC occasions or to the SSB indices. For example, the process 800 may use a prediction model, such as the AI/ML model that may provide measurement predictions for several future SSBs, allowing the corresponding SSB measurements to be skipped by the UE. For instance, as shown in FIG. 5, the UE may predict that the SSB measurements corresponding to the indices 2 and 3 may be skipped in all SMTC occasions 220. As another example, as shown in FIG. 6, the UE may predict that the SSB measurements during several SMTC occasions 610 may be skipped. As a further example, as shown in FIG. 7, the UE may predict that the SSB measurements during several SMTC occasions 610 may be skipped and, in addition, several SSB indices (e.g., the SSB indices 2 and 3) may be skipped in the SMTC occasions 220 during which the other SSB indices (e.g., the SSB indices 0 and 1) are measured.

The process 800, in some embodiments, may perform measurements of a set of one or more KPIs for the prediction model, may compare the measured set of KPIs with one or more thresholds, and may determine the one or more future changes to the SMTC occasions or to the SSB indices based on the comparison. The set of KPIs may include either a set of network-configured KPIs or a set of predetermined KPIs stored in the UE. In some embodiments, in a case that one or more KPIs are below a threshold, the process 800 may deactivate the prediction model based on the comparison. In some embodiments, the process 800 may predict a mobility event and may determine the one or more future changes to the SMTC occasions or to the SSB indices based on the predicted mobility event. The mobility event may be a handover from a first network node in the network to a second network node in the network, an event indicating an RSRP of a first cell of the network is better than an RSRP of a second cell of the network, a combination of both. The first cell of the network may either be a neighbor cell of the network or a serving cell of the network, and the second cell of the network may be the other of the neighbor cell of the network and the serving cell of the network. The first network node may either be a neighbor network node of the network or a serving network node of the network, and the second network node may be the other of the neighbor network node and the serving network node.

In some embodiments, the UE may predict an RLF event and may determine the one or more future changes to the SMTC occasions or to the SSB indices based on the predicted RLF event. some embodiments, the UE may determine a number of retransmissions and may determine the one or more future changes to the SMTC occasions or to the SSB indices based on the determined number of retransmissions.

The process 800 may then generate (at block 820) a report of the predicted one or more future changes. For example, as described above, the process 800 may generate a bitmap using the novel construct SSB-beingMeasured and/or SMTC-beingMeasured of the present embodiments. The process 800 may then transmit the generated report to the network. The process 800 may then end. The process 800, in some embodiments, may receive the SMTC from the network via a SIB. message. The process 800, in some embodiments, may receive the SMTC via RRC signaling.

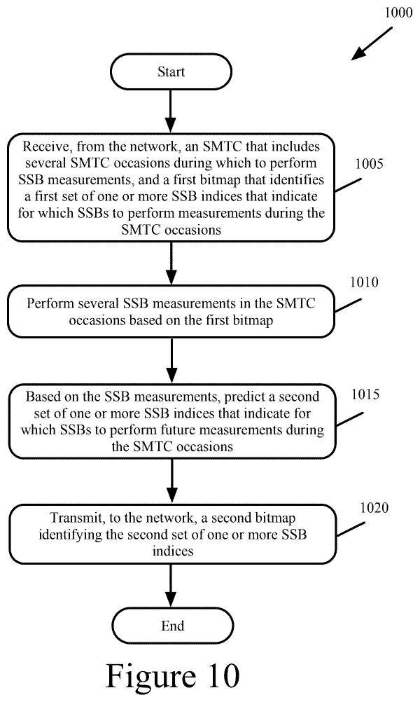

It should be noted that, in some embodiments, the UE may continue making SSB measurements based on the last configurations received from the network node until the UE receives an acceptance from the network. In other embodiments, for example, as described below with reference to FIG. 10, the network node may configure the UE to switch to a different SSB measurement configuration after a certain criteria is met.

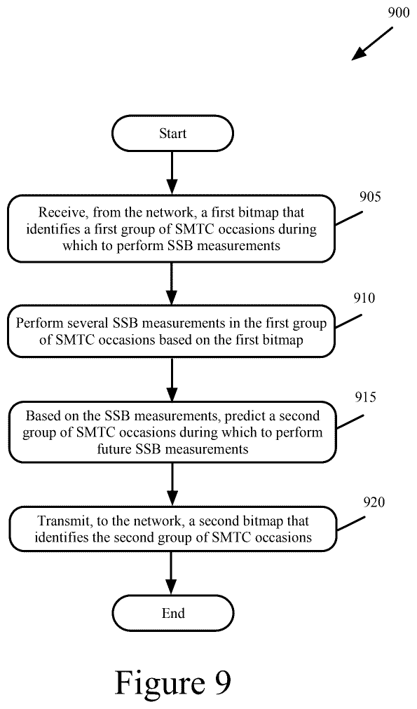

FIG. 9 is a flowchart illustrating an example method/process 900 performed by a UE for predicting one or more future changes to the SMTC occasions and reporting the prediction as a bitmap to the network, according to an example implementation of the present disclosure. The process 900 may be performed by at least one processor of a UE 101A-101C, shown in FIG. 1.

The process 900 may receive (at block 905), from a network node, a first bitmap that identifies a first group of SMTC occasions during which to perform SSB measurements. For example, the process 900 may receive an IE, such as an SMTC-ToMeasure IE, from the network with the corresponding bitmap, similar to the SSB-toMeasure as described above with reference to FIG. 4. The first bitmap may include several bits. Each bit may correspond to an SMTC occasion of the several SMTC occasions identified by the first bitmap. Each bit in may takes either a first value (e.g., 1) or a second value (e.g., 0). The first value may indicate that the corresponding SMTC occasion is an SMTC occasion during which to perform SSB measurements. The second value may indicate that the corresponding SMTC occasion is an SMTC occasion during which to perform no SSB measurements. It should be noted that, alternatively, a 0 may be used to indicate the corresponding SMTC occasion is an SMTC occasion during which to perform SSB measurements, and a 1 may be used to indicate that the corresponding SMTC occasion is an SMTC occasion during which to perform no SSB measurements.

The process 900 may perform (at block 910) several SSB measurements in the first group of SMTC occasions based on the first bitmap. For example, in FIG. 4, the SSBs corresponding to all indices 0, 1, 2, and 3 may be measured by the UE in each SMTC occasion 220.

Based on the SSB measurements, the process 900 may predict (at block 915) a second group of SMTC occasions during which to perform future SSB measurements. The second group of SMTC occasions, in some embodiments, may be different than the first group of SMTC occasions. For example, as shown in FIG. 6, the UE may predict that the SSB measurements during several SMTC occasions 610 may be skipped. The second group of SMTC occasions, in some embodiments, may be the same as the first group of SMTC occasions.

The second bitmap may include several bits. Each bit may correspond to an SMTC occasion of the several SMTC occasions identified by the second bitmap. Each bit in may take either a first value (e.g., 1) or a second value (e.g., 0). The first value may indicate that the corresponding SMTC occasion is an SMTC occasion during which to perform SSB measurements. The second value may indicate that the corresponding SMTC occasion is an SMTC occasion during which to perform no SSB measurements. It should be noted that, alternatively, a 0 may be used to indicate the corresponding SMTC occasion is an SMTC occasion during which to perform SSB measurements, and a 1 may be used to indicate that the corresponding SMTC occasion is an SMTC occasion during which to perform no SSB measurements.

The process 900 may transmit (at block 920), to the network, a second bitmap that identified the second group of SMTC occasions. For example, the process 900 may transmit the SMTC-beingMeasured and the corresponding bitmap to the network as described above with reference to FIG. 6. The process 900 may then end. In some embodiments, the process 900 may transmit the second bitmap via RRC signaling. In some embodiments, the process 900 may transmit the second bitmap via a UAI message. In some embodiments, the process 900 may transmit the second bitmap via a MAC CE.

The process 900, in some embodiments, may receive, from the network, a message indicating an acceptance of the second bitmap. In response to receiving the acceptance, the process 900 may perform several SSB measurements during the SMTCs identified by the second bitmap. The process 900, in some embodiments, may receive, from the network, a message indicating a rejection of the second bitmap. In response to receiving the acceptance, the process 900 may perform several SSB measurements during the SMTCs identified by the first bitmap. In other word, the process 900 may continue using the first bitmap if the second bitmap is rejected by the network.

The process 900, in some embodiments, may receive, from the network, a message that includes a third bitmap indicating a third set of one or more SMTCs during which to perform SSB measurements. The third set of SMTCs may be different than the first set of SMTCs. In response to receiving the message that includes the third bitmap, the process 900 may perform several SSB measurements based on the third bitmap.

FIG. 10 is a flowchart illustrating an example method/process 1000 performed by a UE for predicting one or more future changes to the SSB indices configuration and reporting the prediction as a bitmap to the network, according to an example implementation of the present disclosure. The process 1000 may be performed by at least one processor of a UE 101A-101C, shown in FIG. 1.

The process 1000 may receive (at block 1005), from the network, an SMTC that includes several SMTC occasions during which to perform SSB measurements, and a first bitmap that identifies a first set of one or more SSB indices that indicate for which SSBs to perform measurements during the SMTC occasions. For example, the process 1000 may receive an SSB-ToMeasure with the corresponding bitmap from the network, as described above with reference to FIG. 4. The first bitmap may include several bits. Each bit may correspond to an SSB index identified by the first bitmap. Each bit may a have first value, for example 1, indicating that the corresponding SSB index is an SSB index for which to make measurements. Each bit may have a second value, for example 0, indicating that the corresponding SSB index is an SSB index for which no measurements is to be made. It should be noted that, alternatively, a value of 0 may be used to indicate the corresponding SSB index is an SSB index for which to make measurements, and a value of 1 may be used to indicate that the corresponding SSB index is an SSB index for which no measurements is to be made.

The process 1000 may perform (at block 1010) several SSB measurements in the SMTC occasions based on the first bitmap. For example, in FIG. 4, the SSBs corresponding to all indices 0, 1, 2, and 3 may be measured by the UE in each SMTC occasion 220.

The process 1000, based on the SSB measurements, may predict (at block 1015) a second set of one or more SSB indices that indicate for which SSBs to perform future measurements during the SMTC occasions. The second set of SSB indices, in some embodiments, may be different than the first set of SSB indices. For example, as shown in FIG. 5, the UE may predict that the SSB measurements for several SSB indices (e.g., the SSB indices 2 and 3) may be skipped in each SMTC occasion. The second set of SSB indices, in some embodiments, may be the same as the first set of SSB indices.

The second bitmap may include several bits. Each bit may correspond to an SSB index in the second set of SSB indices in the second set of SSB indices. Each bit may take either a first value or a second value. The first value (e.g., 1) may indicate that the corresponding SSB index is an SSB index for which to perform SSB measurements. The second value (e.g., 0) may indicate that the corresponding SSB index is an SSB index for which to perform no measurements is to be made. It should be noted that, alternatively, a value of 0 may be used to indicate the corresponding SSB index is an SSB index for which to perform SSB measurements, and a value of 1 may be used to indicate that the corresponding SSB index is an SSB index for which to perform no SSB measurements.

The process 1000 may transmit (at block 1020), to the network, a second bitmap identifying the second set of one or more SSB indices. For example, the process 1000 may transmit the SSB-beingMeasured and the corresponding bitmap to the network as described above with reference to FIG. 5. The process 1000 may then end. In some embodiments, the process 1000 may transmit the second bitmap via RRC signaling. In some embodiments, the process 1000 may transmit the second bitmap via a UAI message. In some embodiments, the process 1000 may transmit the second bitmap via a MAC CE.

The process 1000, in some embodiments, may receive, from the network, a message indicating an acceptance of the second bitmap. In response to receiving the acceptance, the process 1000 may perform several SSB measurements based the second bitmap. The process 1000, in some embodiments, may receive, from the network, a message indicating a rejection of the second bitmap. In response to receiving the acceptance, the process 1000 may perform several 1000 measurements based on the first bitmap. In other word, the process 1000 may continue using the first bitmap if the second bitmap is rejected by the network.

The process 1000, in some embodiments, may receive, from the network, a message that includes a third bitmap indicating a third set of one or more SSB indices for which to make measurements. The third set of SSB indices may be different than the first set of SSB indices. In response to receiving the message that includes the third bitmap, the process one or more SSB indices for which to make measurements may perform several SSB measurements based on the third bitmap.

### The Network Aspects and Network-Centered Signaling of Step 5 and Step 6

When the network node 390 receives the SSB-beingMeasured IE and/or SMTC-beingMeasured IE from the UE 101, the network node 390 may accept, reject, or modify either one or both, together or separately.

When the network node 390 receives the SSB-beingMeasured IE and/or the SMTC-beingMeasured IE from the UE 101, the network node 390 may provide an alternative configuration corresponding to the target measurement reduction indicated by the UE 101. For example, this may involve transmitting a new SSB-toMeasure IE to the UE.

In some embodiments, the network may proactively (without the UE feedback with the SSB-beingMeasured IE and/or the SMTC-beingMeasured IE) or reactively (after receiving the SSB-beingMeasured IE and/or the SMTC-beingMeasured IE) provide multiple SSB-toMeasure IEs and/or SMTC configurations. In some examples, the network node 390 may provide KPI thresholds (e.g., accuracy of predicted measurements), based on which the UE 101 may be required to apply appropriate measurement configurations.

In some embodiments, the network node 390 may provide a SMTC and a SMTC_AI (e.g., to be used by the AI/ML mobility functionality) to the UE 101, which may be used to configure the UE 101 to perform measurements correspondingly, for example, based on the required/observed accuracy of the measurement predictions, or the required measurement reporting intervals.

In some embodiments, the network node 390 may provide two SSB-toMeasure IEs or SMTC configurations, one of which may be used when the AI/ML mobility functionality is not activated and the other SMTC configuration may be used when the AI/ML mobility functionality is activated. In another example, the two SMTC configurations may be configured with different skipping/measuring patterns. The UE 101 may be required to inform the network, for example, on the observed accuracy of predicted measurements, which may be utilized by the network to determine the measurement pattern being applied by the UE 101.

In some embodiments, based on the measurement or skipping pattern obtained from several UEs, the network node 390 may implement or configure the UEs with skipping patterns such that they may be fully overlapping or fully non-overlapping or partially overlapping.

In a case the UEs are configured such that the measurement patterns are fully overlapped, it may allow the network node 390 to skip the transmission of SSB/reference signals on the occasions/SSB indices where the network expects that no (or not enough) UEs would need to perform measurements. This may result in significant reduction in signaling.

In a case where the UEs are configured for measurements in a non-overlapping manner, the network node 390 may find additional transmission/scheduling opportunities for different UEs separately, which may result in higher system throughput. In some embodiments, in case the UEs are configured such that the measurement patterns are fully overlapped, it may allow the network node 390 to configure group discontinuous reception (DRX) to the corresponding UEs.

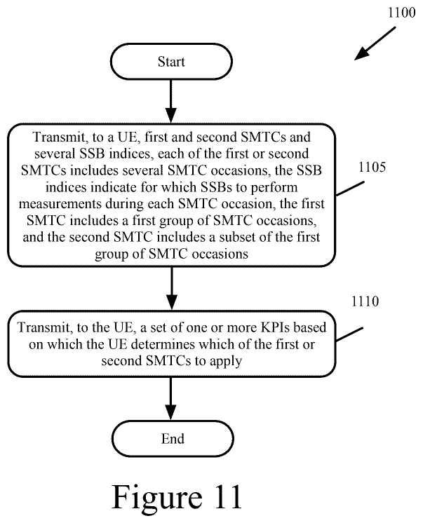

FIG. 11 is a flowchart illustrating an example method/process 1100 performed by a network node for providing several SMTCs to a UE, according to an example implementation of the present disclosure. The process 1100 may be performed by at least one processor of a network node, such as the BS 103, shown in FIG. 1.

The process 1100 may transmit (at block 1105), to the UE, first and second SMTCs and several SSB indices. Each of the first or second SMTCs may include several SMTC occasions. The SSB indices may indicate for which SSBs to perform measurements during each SMTC occasion. The first SMTC may include a first group of SMTC occasions, and the second SMTC may include a subset of the first group of SMTC occasions. The process 1100, in some embodiments, may transmit the first and second SMTCs to the UE via one or more SIB messages. The process 1100, in some embodiments, may transmit the first and second SMTCs to the UE via one or more RRC messages.

The process 1100 may transmit (at block 1110), to the UE, a set of one or more KPIs based on which the UE determines which of the first or second SMTC to apply. The process 1100 may then end. Each KPI may include a first parameter that indicates the type of the KPI and a second parameter that indicates at least one value for the KPI. The process 1100, in some embodiments, may configure the UE with a prediction model, such as an AI/ML model. The prediction model may indicate which of the first and second SMTCs to apply based on measurements, by the UE, of values of the KPIs in the set of the KPIs. The process 1100, in some embodiments, may further configure the prediction model of the UE to determine which of the first and second SMTCs to apply based on whether a prediction model is configured, the prediction model is available, the prediction model is valid, or the prediction model is activated.

The process 1100, in some embodiments, may receive, from the UE, a prediction for one or more future changes to the second SMTC occasions. In some of these embodiments, the process 1100 may transmit the first and second SMTCs to the UE prior to the receiving of the prediction from the UE. In other embodiments, the process 1100 may transmit the first and second SMTCs in response to receiving of the prediction from the UE.

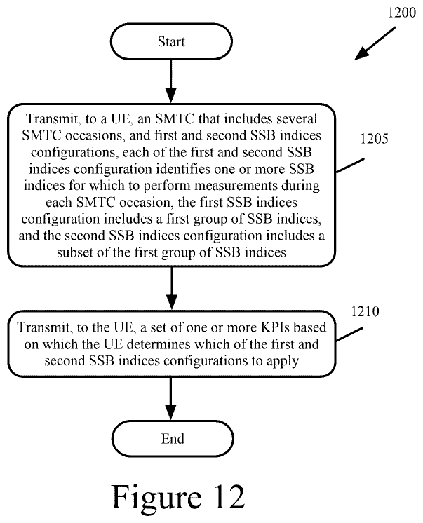

FIG. 12 is a flowchart illustrating an example method/process 1200 performed by a network node for providing several SSB indices configurations to a UE, according to an example implementation of the present disclosure. The process 1200 may be performed by at least one processor of a network node, such as the BS 103, shown in FIG. 1.

The process 1200 may transmit (at block 1205), to the UE, an SMTC that includes several SMTC occasions, and first and second SSB indices configurations. Each of the first and second SSB indices configuration identifies one or more SSB indices for which to perform measurements during each SMTC occasion. The first SSB indices configuration includes a first group of SSB indices, and the second SSB indices configuration includes a subset of the first group of SSB indices.

The process 1200, in some embodiments, may transmit the first and second SSB indices configurations to the UE via one or more SIB messages. The process 1200, in some embodiments, may transmit the first and second SSB indices configurations to the UE via one or more RRC messages.

The process 1200 may transmit (at block 1210), to the UE, a set of one or more KPIs based on which of the first and second SSB indices configurations to apply. The process 1200 may then end.

Each KPI may include a first parameter that indicates the type of the KPI and a second parameter that indicates at least one value for the KPI. The process 1200, in some embodiments, may configure the UE with a prediction model, such as an AI/ML model. The prediction model may indicate which of the first and second SSB indices configurations to apply based on measurements, by the UE, of values of the KPIs in the set of the KPIs by the UE, the process 1200, in some embodiments, may further configure the prediction model of the UE to determine which of the first and second SSB indices configurations to apply based on whether a prediction model is configured, the prediction model is available, the prediction model is valid, or the prediction model is activated.

The process 1200, in some embodiments, may receive, from the UE, a prediction for one or more future changes to the second SSB indices configuration. In some of these embodiments, the process 1200 may transmit the first and second SSB indices configurations to the UE prior to the receiving of the prediction from the UE. In other embodiments, the process 1200 may transmit the first and second SSB indices configurations in response to receiving of the prediction from the UE.

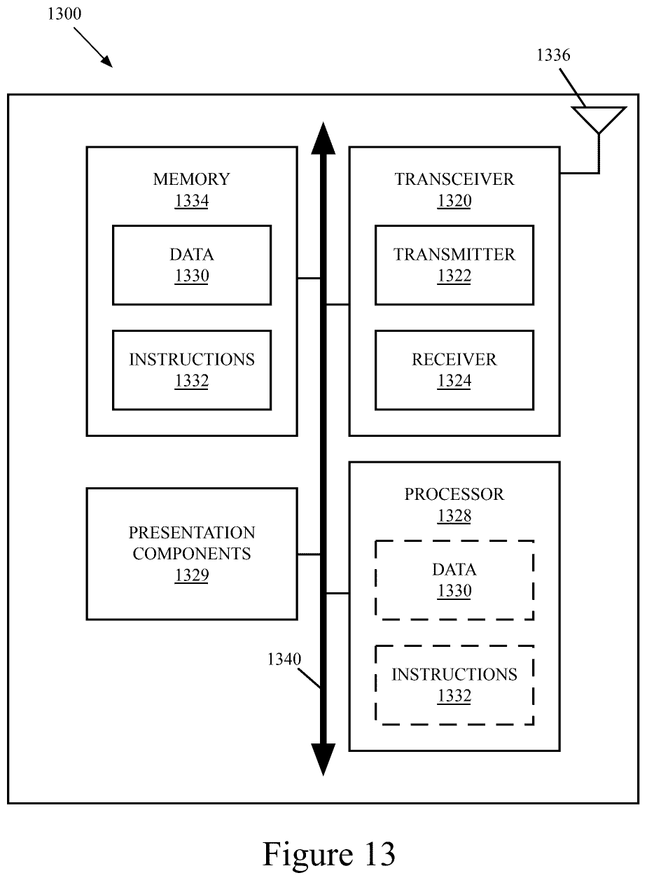

FIG. 13 is a block diagram illustrating a node 1300 for wireless communication, according to an example implementation of the present disclosure. As illustrated in FIG. 13, a node 1300 may include a transceiver 1320, a processor 1328, a memory 1334, one or more presentation components 1329, and at least one antenna 1336. The node 1300 may also include a radio frequency (RF) spectrum band module, a BS communications module, a network communications module, and a system communications management module, Input/Output (I/O) ports, I/O components, and a power supply (not illustrated in FIG. 13).

Each of the components may directly or indirectly communicate with each other over one or more buses 1340. The node 1300 may be a UE, a BS, a LMF server, or any other network node on the RAN side or CN side that performs various functions disclosed with reference to FIGS. 1 through 12.

The transceiver 1320 has a transmitter 1322 (e.g., transmitting/transmission circuitry) and a receiver 1324 (e.g., receiving/reception circuitry) and may be configured to transmit and/or receive time and/or frequency resource partitioning information. The transceiver 1320 may be configured to transmit in different types of subframes and slots including, but not limited to, usable, non-usable, and flexibly usable subframes and slot formats. The transceiver 1320 may be configured to receive data and control channels.

The node 1300 may include a variety of computer-readable media. Computer-readable media may be any available media that may be accessed by the node 1300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 1334 may include computer-storage media in the form of volatile and/or non-volatile memory. The memory 1334 may be removable, non-removable, or a combination thereof. Example memory may include solid-state memory, hard drives, optical-disc drives, etc. As illustrated in FIG. 13, the memory 1334 may store a computer-readable and/or computer-executable instructions 1332 (e.g., software codes) that are configured to, when executed, cause the processor 1328 to perform various functions disclosed herein, for example, with reference to FIGS. 1 through 12. Alternatively, the instructions 1332 may not be directly executable by the processor 1328 but may be configured to cause the node 1300 (e.g., when compiled and executed) to perform various functions disclosed herein.

The processor 1328 (e.g., having processing circuitry) may include an intelligent hardware device, e.g., a Central Processing Unit (CPU), a microcontroller, an ASIC, etc. The processor 1328 may include memory. The processor 1328 may process the data 1330 and the instructions 1332 received from the memory 1334, and information transmitted and received via the transceiver 1320, the baseband communications module, and/or the network communications module. The processor 1328 may also process information to send to the transceiver 1320 for transmission via the antenna 1336 to the network communications module for transmission to a CN.

One or more presentation components 1329 may present data indications to a person or another device. Examples of presentation components 1329 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the “computer system” mentioned here refers to a computer system built into the terminal device or the BS, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment may also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions; and
at least one processor coupled to the one or more non-transitory computer-readable media, and configured to execute the one or more computer-executable instructions to cause the UE to:
receive, from a network, a first bitmap identifying a first plurality of measurement timing configuration (SMTC) occasions during which to perform synchronization signal block (SSB) measurements;
perform a plurality of SSB measurements in the first plurality of SMTC occasions based on the first bitmap;
based on the plurality of SSB measurements, predict a second plurality of SMTC occasions during which to perform future SSB measurements, the second plurality of SMTC occasions different than the first plurality of SMTC occasions; and
transmit, to the network, a second bitmap identifying the second plurality of SMTC occasions.

2. The UE of claim 1, wherein:
the first bitmap comprises a plurality of bits,
each bit in the plurality of bits corresponds to an SMTC occasion in the first plurality of SMTC occasions,
each bit in the plurality of bits takes one of a first value or a second value,
the first value indicates that the corresponding SMTC occasion is an SMTC occasion during which to perform SSB measurements, and
the second value indicates that the corresponding SMTC occasion is an SMTC occasion during which to perform no SSB measurements.

3. The UE of claim 1, wherein:
the second bitmap comprises a plurality of bits,
each bit in the plurality of bits corresponds to an SMTC occasion in the second plurality of SMTC occasions,
each bit in the plurality of bits takes one of a first value or a second value,
the first value indicates that the corresponding SMTC occasion is an SMTC occasion during which to perform SSB measurements, and
the second value indicates that the corresponding SMTC occasion is an SMTC occasion during which to perform no SSB measurements.

4. The UE of claim 1, wherein transmitting the second bitmap to the network comprises one of transmitting the second bitmap via radio resource control (RRC) signaling, transmitting the second bitmap via a UE assistance information (UAI) message, or transmitting the second bitmap via a medium access control element (MAC CE).

5. The UE of claim 1, wherein:
the at least one processor is further configured to execute the one or more computer-executable instructions to cause the UE to:
receive, from the network, a message indicating an acceptance of the second bitmap, and
in response to receiving the acceptance, perform a plurality of SSB measurements during the SMTCs identified by the second bitmap.

6. The UE of claim 1, wherein:
the at least one processor is further configured to execute the one or more computer-executable instructions to cause the UE to:
receive, from the network, a message indicating a rejection of the second bitmap, and
in response to receiving the rejection, perform a plurality of SSB measurements during the SMTCs identified by the first bitmap.

7. The UE of claim 1, wherein:
the at least one processor is further configured to execute the one or more computer-executable instructions to cause the UE to:
receive, from the network, a message comprising a third bitmap indicating a third set of one or more SMTCs during which to perform SSB measurements, the third set of SMTCs different than the first set of SMTCs; and
in response to receiving the message comprising the third bitmap, perform a plurality of SSB measurements based on the third bitmap.

8. A user equipment (UE), comprising:
one or more non-transitory computer-readable media storing one or more computer-executable instructions; and
at least one processor coupled to the one or more non-transitory computer-readable media, and configured to execute the one or more computer-executable instructions to cause the UE to:
receive, from a network, a synchronization signal block (SSB) measurement timing configuration (SMTC) comprising a plurality of SMTC occasions during which to perform SSB measurements, and a first bitmap identifying a first set of one or more SSB indices, the first set of one or more SSB indices indicating for which SSBs to perform measurements during the plurality of SMTC occasions;
perform a plurality of SSB measurements in the plurality of SMTC occasions based on the first bitmap;
based on the plurality of SSB measurements, predict a second set of one or more SSB indices indicating for which SSBs to perform future measurements during the plurality of SMTC occasions; and
transmit, to the network, a second bitmap identifying the second set of one or more SSB indices.

9. The UE of claim 8, wherein:
the first bitmap comprises a plurality of bits,
each bit in the plurality of bits corresponds to an SSB index in the first set of SSB indices,
each bit in the plurality of bits takes one of a first value or a second value,
the first value indicates the corresponding SSB index is an SSB index for which to perform SSB measurements, and
the second value indicates the corresponding SSB index is an SSB index for which to perform no SSB measurements.

10. The UE of claim 8, wherein:
the second bitmap comprises a plurality of bits,
each bit in the plurality of bits corresponds to an SSB index in the second set of SSB indices,
each bit in the plurality of bits takes one of a first value or a second value,
the first value indicates the corresponding SSB index is an SSB index for which to perform SSB measurements, and
the second value indicates the corresponding SSB index is an SSB index for which to perform no SSB measurements.

11. The UE of claim 8, wherein transmitting the second bitmap to the network comprises one of transmitting the second bitmap via radio resource control (RRC) signaling, transmitting the second bitmap via a UE Assistance Information (UAI) message, or transmitting the second bitmap via a medium access control element (MAC CE).

12. The UE of claim 8, wherein:
the at least one processor is further configured to execute the one or more computer-executable instructions to cause the UE to:
receive from the network, a message indicating an acceptance of the second bitmap, and
in response to receiving the acceptance, perform a plurality of SSB measurements based on the second bitmap.

13. The UE of claim 8, wherein:
the at least one processor is further configured to execute the one or more computer-executable instructions to cause the UE to:
receive, from the network, a message indicating a rejection of the second bitmap, and
in response to receiving the rejection, perform a plurality of SSB measurements based on the first bitmap.

14. The UE of claim 8, wherein:
the at least one processor is further configured to execute the one or more computer-executable instructions to cause the UE to:
receive from the network, a message comprising a third bitmap indicating a third set of one or more SSB indices for which to make measurements, the third set of SSB indices different than the first set of SSB indices; and
in response to receiving the message comprising the third bitmap, perform a plurality of SSB measurements based on the third bitmap.

15. A method, comprising:
receiving, by a user equipment (UE), from a network, a first bitmap identifying a first plurality of measurement timing configuration (SMTC) occasions during which to perform synchronization signal block (SSB) measurements;
performing a plurality of SSB measurements in the first plurality of SMTC occasions based on the first bitmap;
based on the plurality of SSB measurements, predicting a second plurality of SMTC occasions during which to perform future SSB measurements; and
transmitting, to the network, a second bitmap identifying the second plurality of SMTC occasions.
